(19) United States
(12) Patent Application Publication
(10) Pub. No.: US 2008/0154806 A1
(43) Pub. Date: Jun. 26, 2008

(54) Methods, systems, and computer program products for a self-automating set of services or devices

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/644,123

(22) Filed: Dec. 22, 2006

(51) Int. Cl. G06F 15/18

(52) U.S. Cl. 706/12

(57) ABSTRACT

Methods, systems, and computer program products for a self-automating set of services or devices are disclosed. According to one method, a signal is received. A first action having a first correlation with the first signal is received. The first action is performed if the correlation of the first action with the first signal meets a threshold condition. Input associated with a second action is received after performing the first action. The correlation of the first action with the received signal is adjusted based on the second action. The process is performed while in the mode for providing a service and for device interoperability learning.

### TECHNICAL FIELD

The subject matter described herein relates to making devices and/or services work together. More particularly, the subject matter described herein relates to methods, systems, and computer program products for a self-automating set of services or devices.

### BACKGROUND

It is often desirable to enable separate services or devices to work together. For example, in the field of consumer electronics, it is desirable to enable a remote control device to control a separate electronic device, such as a television. One possible way to enable devices to work together is to preconfigure the devices to work together. For example, the remote control that is shipped by a manufacturer with a television made by the manufacturer is preconfigured to control the television. However, preconfigured interoperability requires coordination between device manufacturers or compliance with a common standard. As a result, preconfigured interoperability is not always possible, especially when devices or services are provided by different entities.

Another possible solution to enabling separate devices or services to work together is to have the end user configure the devices or services to work together. Continuing with the television remote control example, so called universal remote controls are preconfigured with a set of access codes for activating televisions made by different manufacturers. In order to configure a universal remote control to work with a television made by a particular manufacturer, the user must manually proceed through the set of pre-programmed access codes until the user locates the code that activates the television. Once the user locates the access code for the television, the user instructs the remote control to use this code.

One problem with this and other device interoperability configuration mechanisms is that the configuration process is labor intensive and prone to user error. Continuing with the television remote control example, the user can be required to scroll through tens or hundreds of codes for different manufacturers or models. In addition, the user must perform detailed steps for scrolling through the access codes and selecting the correct code.

Another problem with conventional device interoperability configuration mechanisms is that at least one of the devices is required to know in advance the meaning of the signal transmitted by the other device. For example, in the television remote control example, the television is required to know its access code in advance.

Yet another problem with conventional device interoperability configuration methods is that they lack flexibility. For example, a user may desire to associate an arbitrary signal originating from one device with an arbitrary action of another device. Conventional interoperability configuration mechanisms, such as the television remote control programming method described above, only allow predefined signal inputs to invoke predefined actions. There is no ability for the user to define an input, an action, and a correlation between the input and the action.

Yet another problem with conventional device interoperability configuration mechanisms is that the associations between signals of one device and actions of another device are binary. That is, a signal is either associated with an action or not. There is no ability to associate a signal with an action with more than two association or correlation levels.

Yet another problem with conventional device interoperability configuration mechanisms is that most of these mechanisms require bimodal operation. That is, the devices being configured to work together must first operate in learning mode where signals are associated with actions. In learning mode, the controlled device is typically not operational for providing a service. Once the association between signals and actions is made, the controlled device must transition to operating mode. In operating mode, the controlled device typically cannot learn new associations between signals and actions. There is no ability for a device to operate while in learning mode or to learn while in operating mode.

Accordingly, in light of these difficulties associated with conventional mechanisms for configuring devices to work together, there exists a need for improved methods, systems, and computer program products for a self-automating set of services or devices.

### SUMMARY

The subject matter described herein includes methods, systems, and computer program products for a self-automating set of services or devices. According to one aspect, a method for a self-automating set of services or devices includes receiving a signal. A first action having a correlation with the received signal is determined. The first action is performed if the correlation of the first action with the received signal meets a threshold condition. Input including input associated with a second action is received after performing the first action. The correlation of the first action with the received signal is adjusted based on the second action. The method is performed while in a mode for providing a service and for device interoperability learning.

According to another aspect, a method for a self-automating set of services or devices includes receiving a signal at a device. An association including the signal, an action, and a correlation between the signal and the action is located. The correlation is a member of a set of correlations having at least three members. The action is performed when indicated by a policy based on the correlation.

According to another aspect, a system for a self-automating set of services or devices includes an input/output (I/O) subsystem for receiving a first signal and for receiving input after receiving the first signal. The system includes a policy manager for, while in a mode for providing a service and for device interoperability learning, receiving the first signal from the I/O subsystem, determining a first action having a first correlation with the first signal, performing the first action if the correlation meets a threshold condition, receiving the input from the I/O subsystem, the input being associated with the second action, and adjusting the first correlation based on the second action.

### BRIEF DESCRIPTION OF THE DRAWINGS

Preferred embodiments of the subject matter described herein will now be explained with reference to the accompanying drawings of which:

FIG. 1 is a flow chart illustrating an exemplary process with a self-automating set of services or devices according to an embodiment of the subject matter described herein;

FIG. 2 is a block diagram illustrating an exemplary system for a self-automating set of services or devices according to an embodiment of the subject matter described herein;

FIG. 3 is a flow chart of an exemplary process for a self-automating set of services or devices according to an embodiment of the subject matter described herein; and

FIG. 4 is a block diagram illustrating exemplary services or devices that may be self-automated according to an embodiment of the subject matter described herein.

### DETAILED DESCRIPTION

The subject matter described herein includes methods, systems, and computer program products for a self-automating set of services or devices. As used herein, the terms “device” and “service” refer to any suitable hardware, software, and/or firmware implemented function that is desirable to inter-work or inter-operate with another hardware, software, or firmware implemented function. Examples of devices or service pairs that it may be desirable to inter-work or inter-operate using the subject matter described herein include remote controllers and televisions, remote controllers and digital video recorders, remote controllers and audio systems, mobile phones and audio or video components, audio components and video components, etc.

The subject matter described herein for a self-automating set of services or devices may be implemented using a computer readable medium containing a computer program executable by a machine. The computer program may include executable instructions for a self-automating set of services or devices. Examples of computer readable media suitable for implementing the subject matter described herein include disk memory devices, chip memory devices, programmable logic devices, application specific integrated circuits, and downloadable electrical signals. In addition, a computer readable medium that implements the subject matter described herein may be located on a single device for computing platform or may be distributed across multiple devices or computing platforms.

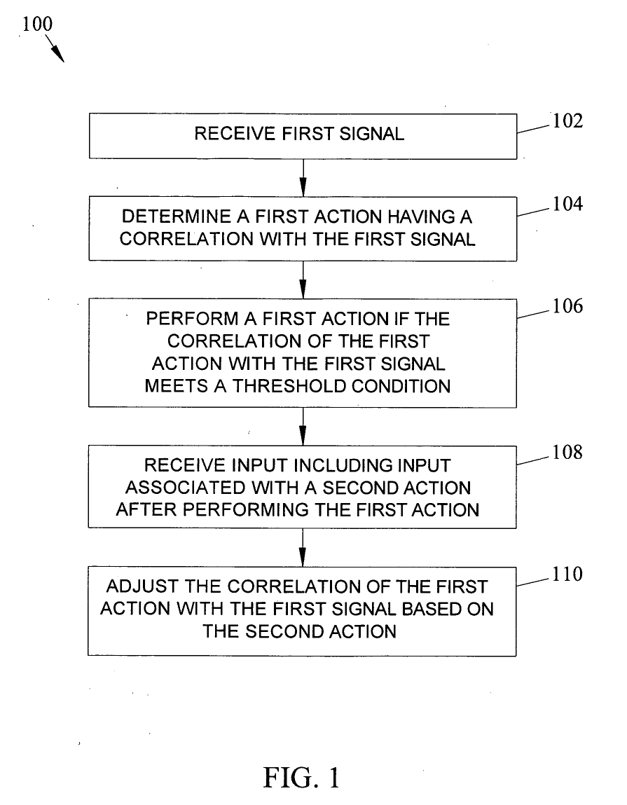

FIG. 1 depicts a method 100 for automating the operation of a device or service as a result of operating the device or service.

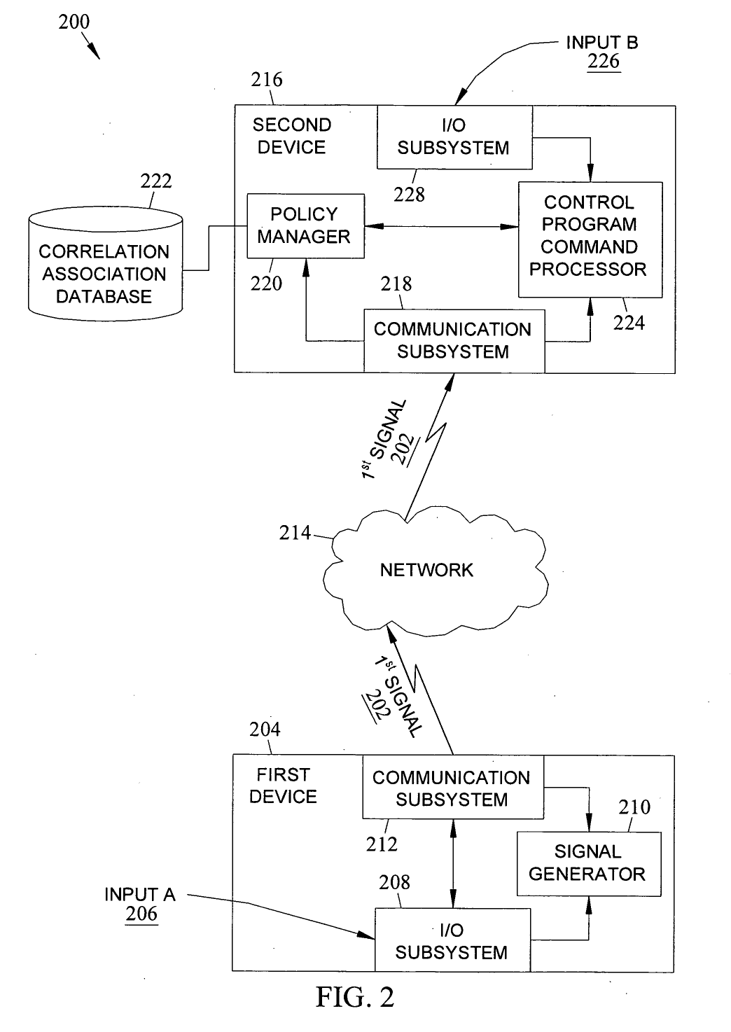

FIG. 2 depicts an exemplary system 200 including the components of a preferred embodiment that in operation embodies the steps of method 100.

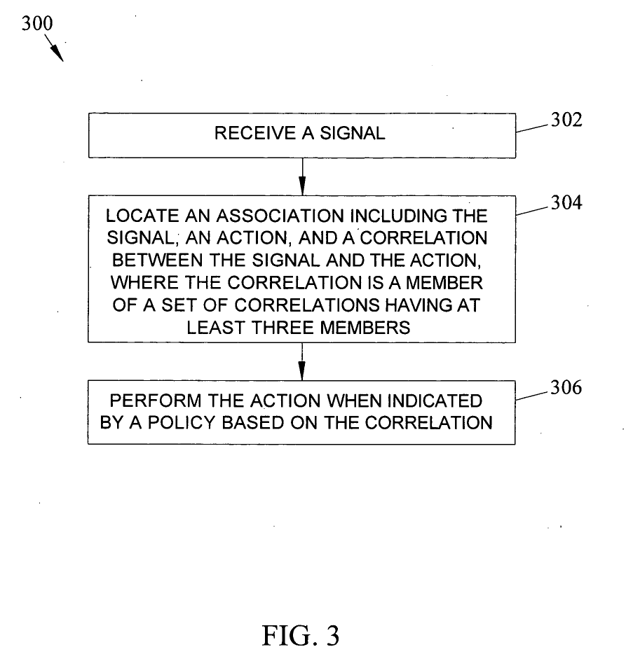

FIG. 3 illustrates a second method 300 for automating the operation of a device or service as a result of operating the device or service. Methods 100 and 300 can be combined without departing from the scope of the subject matter described herein. Alternatively, methods 100 and 300 can be performed independently of one another. The operation of system 200 is described below and illustrates the operation of each of methods 100 and 300.

FIG. 1 is a flow chart of a process 100 for a self-automating set of services or devices according to an embodiment of the subject matter described herein. Process 100 may be performed when a device is in a mode for providing a service and for device interoperability learning. For example, if the devices being configured to operate together are audio components, process 100 may be performed by one of the devices when the device is in a mode where the device can provide a service for which it was designed, such as playing audio files to a user, and learning to interoperate with the other device.

Referring to FIG. 1, at block 102 of method 100, a first signal is received. In system 200 illustrated in FIG. 2, a first signal 202 is generated by a first device 204, for example, when an input A 206 is received by an input/output (I/O) subsystem 208 of first device 204. In the example, input A 206 is received by an application (not shown) and processed, resulting in the performing of an operation. For example, a user pushes a power button of a DVR causing the DVR to power up and initialize. A result of the processing causes signal 202 to be generated by a signal generator 210, thus transforming input A 206 into signal 202. Signal generator 210 invokes a communication subsystem 212 of first device 204 causing signal 202 to be sent over a network 214, allowing it to be received by one or more networked devices, such as a second device 216.

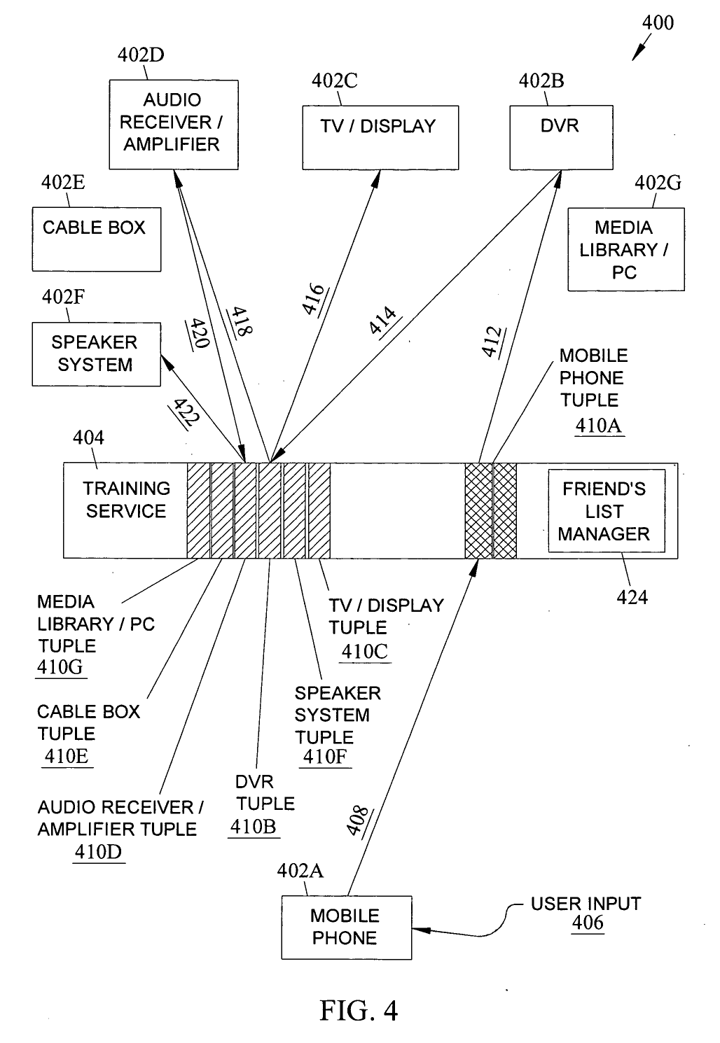

In one embodiment, signal 202 is broadcast so that all devices listening on a particular broadcast address receive the signal. In another embodiment, signal 202 is sent to a service (not shown in FIG. 2) which relays signal 202 to one or more receiving devices. An exemplary second embodiment is depicted as system 400 in FIG. 4 and is described in more detail below. In either embodiment, signals may be sent to a targeted receiver or group of receivers or may be sent to all receivers. The signal may have meaning from the sender's perspective or it may be a randomly generated or configured signal that is associated with the processing which caused its creation when it is received and unrecognized.

Second device 216 receives signal 202 via a communication subsystem 218 of second device 216. Signal 202 is passed to a policy manager 220 for processing.

Referring to FIG. 3, in method 300, block 302 corresponds to block 102 of method 100 in some embodiments. In the present example, system 200 in operation performs the steps of methods 100 and 300. Thus, in the example, the blocks 102 and 302 are equivalent. Like process 100, process 300 may be performed when a device is in a mode for providing a service and for supporting device interoperability learning.

In the present example, policy manager 220 attempts to locate an association in a correlation association database 222 that stores associations that include a signal identifier, an action identifier, and a correlation indicating the strength of the association between the identified signal and action. When a received signal has no association that includes the signal's identifier, various embodiments may respond differently. In one embodiment, the policy manager 220 ignores the signal. In another embodiment, policy manager 220 creates an association including the signal, an identifier associated with no action, and a default correlation for the association, and stores the created association in the correlation association database 222. In this document, this type of association is referred to as a “no-op” association. In yet another embodiment, policy manager 220 creates an association including the signal, and an identifier associated with an action selected by policy manager 220 using a “new signal” policy. A “new signal” policy may be specified to select an action supported by the receiving device at random, may be based on the current state of the receiver, or may be a pre-configured choice. Policy manager 220 includes a correlation in the new association that is also determined by the “new signal” policy that, for example, may use a randomly generated correlation, determine a correlation based on some data or aspect of the receiver, or may be a pre-configured choice. New associations where an action and correlation are associated with an unrecognized signal are referred to herein as speculative associations. The new speculative association is stored in the correlation association database 222 at the request of policy manager 220.

In the present example, an association including signal 202 exists in correlation association database 222. It may have been received before or may have been pre-configured by a manufacture, reseller, or installer, for example.

At a block 304 of method 300 illustrated in FIG. 3, an association is located where the association includes the signal, an action, and a correlation used as a strength indicator of the association between the signal and the first action, for example. The correlation is numeric or non-numeric depending on the embodiment. The correlation is not a simple binary on/off indicator in a preferred embodiment. In an exemplary embodiment the correlation value is a member of a set that has at least 3 values and preferably is a real number in the range from zero to the maximum supported by the host system or is any number between 0 and 1 excluding 0 and 1, although other embodiments may include 0 and 1.

Continuing with the example, block 304 is realized in system 200 when policy manager 220 locates an association in the correlation association database 222 that includes the signal, an action, and a correlation between the signal and the first action.

Method 100 also includes block 104 where a first action is determined that has a correlation with the first signal. The correlation can have any number of values. In one example, the correlation is selected from a set of correlations including at least three members, such as low, medium, and high.

In the example, system 200 in operation performs block 304 of method 300 as previously described, but does it in a particular manner where policy manager 220 sends a query to correlation association database 222 to locate an association including the signal, an action, and a correlation that is the strongest correlation in the associations including the signal in correlation association database 222.

Thus, system 200 as described realizes block 304 of method 300 and block 104 of method 100 in its particular manner of locating an association including the signal, an action, and a correlation.

At block 306 of method 300, a policy indicating whether the action is to be performed is evaluated using the correlation in the association of the signal and the action. The policy indicates the action is to be performed, thus the action is performed. In block 106 of method 100, when the correlation meets a threshold condition, the first action is performed. Thus, block 106 is a special case of block 306 where the policy of block 306 is based on determining whether the correlation meets a threshold condition.

In system 200, policy manager 220 applies a policy, which determines whether the correlation of the located association meets a threshold condition. The threshold in some cases is configured, and in others, it is determined dynamically based on contextual information. In the example, the policy is met, when the correlation meets the threshold used by the policy. In other policy implementations a threshold condition may be met when a correlation is less than the threshold. In still another implementation of a policy, a threshold condition is met when a correlation is between a pair of thresholds. As a result, policy manager 220 provides an indication to a control program or command processor 224 referred to hereinafter as control program 224 to perform the first action. Control program 224 subsequently performs the action.

For example, a DVR, first device 204, sends signal 202 via network 214 as a result of receiving a power on input A 206. The signal is received by a display device, second device 216, which associates the signal with an action that puts the display in a state allowing the DVR to be the input source for the display as a result of previous operation. This is described in more detail below. The association is stored in a data store of the display, correlation association database 222, where it is located by policy manager 220, which applies a policy using the correlation in the located association. The policy is met causing control program 224 of the display to perform the action. In the present example, the display is not fully powered, thus control program 224 brings up the power level of the display and performs any operations necessary to carry out the associated action allowing the display to receive source input from the DVR via a network connection.

At block 108 of method 100, input is received after signal 202 is received. The input may be context input intended to provide context for the first signal. Context input includes, for example, another signal received, a signal generated and sent from the receiving device, an input associated with an action, such as the pressing of a play button on a DVR, state/status information associated with other resources in the receiving device, and/or on the network. The context input may include an input associated with a second action after the first action is performed which is after the first signal is received as indicated in block 104.

Continuing with the example, an input B 226 is received via an I/O subsystem 228 of second device 216. Input B 226 is received via a press of a hardware button, a software button, or other UI control on second device 216. In another situation, the input is received via a peripheral device, such as a remote control using an infrared beam or a mobile phone using a BLUETOOTH™ link to send an input. Inputs are associated with actions directly. For example, pressing the play button on a DVR or a DVR remote generates input associated with the play command. A signal may be associated with an action through an input associated with an action. Thus, for example, a received signal may be associated with an action by receiving of an input associated with the action where the receiving of the signal and the receiving of the action are correlated in time. That is, the association is trained or learned, so to speak, through normal operation of the device or service.

I/O subsystem 228 provides a representation of input B 226 to control program 224. Control program 224 is configured to translate an input into an action, which can be a no-op or no action. In the present example, input B 226 is associated with a second action. The second action and the first action can be equivalent or different actions.

At block 110 of method 100, the correlation of the first action with the first signal is adjusted based on the second action associated with the input received in block 108. For example, if the first and second actions are determined to be equivalent, the correlation of the first signal and the first action may be strengthened. If the first and second actions are not equivalent, the correlation of the first signal with the first action may be weakened. In addition, the correlation may be selected from a set including at least three members, as described above. The set may be a continuous set, a non-continuous set, a finite, or an infinite set.

In system 200, continuing with the example described above, control program 224 may immediately perform the second action as programmed. In other embodiments, further processing is performed before a determination is made that the second action should be performed or not. In either case, control program, 224 determines whether the first action associated with signal 202 is the same or equivalent to the second action associate with the input B 226.

Depending on the determination, policy manager 220 is asked to do different things. In some embodiments, the determination of equivalence is made by policy manager 220. When the determination is that the first action and the second action are equivalent, policy manager 220 adjusts the correlation in the association of the first signal with the first action, which is the same as the second action. Typically, the adjustment strengthens the correlation in the association by strengthening the correlation, for example, thus making the performance of the first action more likely when the signal 202 is received again.

When the determination is that the first action and the second action are not equivalent, in one example, policy manager 220 adjusts the correlation in the association of the signal 202 with the first action. Typically, the adjustment weakens the correlation in the association by decreasing the correlation, for example, thus making the performance of the first action less likely when the signal 202 is received again.

Additionally, policy manager 220 attempts to locate a second association in the correlation association database 222 where the association includes signal 202, the second action, and a second correlation. If the association is located, policy manager 220 adjusts the second correlation. Typically, the second correlation is strengthened that may involve making the correlation higher or lower depending on the implementation. When a second association is not located, policy manager 220 creates a second association including the signal 202, the second action, and a second correlation determined via dynamic processing and/or by configuration. In either case, the result is that when signal 202 is received again, the second action is more likely to meet the conditions of the policy applied than it was when the signal 202 was received in block 102 of method 100. Additionally, in a preferred embodiment, the association including signal 202 and the first action has its correlation adjusted. Typically, the correlation is weakened, thus decreasing the likelihood that the first action will be executed.

The association of a signal with context input can occur in a number of ways. Further, the association of a signal with context input can be affected by a number of factors including attributes of the context input itself. For example, the time between the receiving of a signal and the receiving of an input associated with an action plays a role in the correlation included in the association in some embodiments. For example, in one embodiment, the longer the time period, the weaker the correlation is made. Other factors that affect the creation or adjustment to an existing association between a signal and context input include the identity of the provider, which may be a user and/or may be another device for example, the status/state of other devices, and the current status of an existing association including a signal and an action associated with a received input of a context input.

When the first signal referred in FIG. 1 is received again, based on the association between the signal and the context input, an action is performed. In system 200, when signal 202 is received a second time by the second device 216, the processing is analogous to that already described with respect to the receiving of signal 202 the first time. In the example, signal 202 is passed to policy manager 220 via communication subsystem 218 from network 214.

In one example, signals are opaque in that they carry no inherent information. A sending and/or a receiving device imparts meaning to a signal based on the operation of the relevant device and context input received associated with the signal. In an alternate embodiment, the signal can convey information to one or both of the sender and receiver. For example, the sender may know an identifier of the receiver, the receiver may know which device sent the signal, and the signal may include action information identifying an action performed that resulted in the generation and sending of the signal.

In the present example, policy manager 220 performs a lookup for association records including signal 202 in correlation association database 222 to locate a set of associations, which in the example has the member association that includes signal 202, the first action, and the correlation; and the member association that includes signal 202, the second action, and the second correlation. Policy manager 220, in this example, determines the association in the set that has the strongest correlation between the signal 202 and the included action. Policy manager 220 applies a policy using one or more of the correlations of the set for the purpose of determining what if any action should be performed.

In the present example, the policy used by policy manager 220 determines whether the strongest correlation meets a threshold condition. If the threshold is met, policy manager 220 invokes control program 224 to perform the action identified in the association with the strongest correlation passing the action identifier from the association. In one example, policy manager 220 also adjusts the strongest correlation, typically strengthening it, and stores the association in correlation association database 222. Some embodiments also adjust the other associations in the set, typically weakening them and storing them in correlation association database 222. In another embodiment, policy manager 220 inspects all correlated associations and invokes control program 224 to perform all the actions in an association where the correlation meets a threshold condition.

If the threshold is not met, policy manager 220 in one embodiment ignores signal 202. In an extension to this embodiment, policy manager 220 adjusts the correlation of the association with the strongest correlation as well as other correlations of the other associations of the set, typically weakening the correlations in all associations that do not trigger an action.

In a further embodiment, an association with a strongest correlation is not located. Rather a policy is applied to each of the associations of the located set. Each association with a correlation that causes the policy to be met causes the identified action in the association to be performed. Each association has its correlation adjusted by the policy manager. Typically, the correlations that cause the policy to be met are strengthened, and correlations that result in the policy not being met typically weakened.

The processes illustrated in FIGS. 1 and 3 can be performed by a device or service capable of performing an action associated with a signal or by a proxy server associated with the device capable of performing an action associated with a signal. That is, the methods may be performed by a proxy of one or more devices capable of performing actions included in associations managed by the proxy or the methods may be performed by one or more of the devices. Any suitable system that is capable of configuring devices to interoperate with each other may implement the processes illustrated in FIGS. 1 and 3.

FIG. 4 depicts a system 400, which is one variant of system 200 in FIG. 2 previous described. In system 200, devices receiving signals are self-training. In system 400, the devices may be conventional devices that are configured to respond to input associated with commands rather than signals whose meaning may change as a result of operation of the system. In system 400, at least some of devices 402a-g are enabled to generate and send signals over a network (not shown) to a training service 404, which uses self-training in the manner of methods 100 and 300 to control the devices 402a-b.

For example, a mobile phone 402a receives user input 406 and processes the input including the generation and sending of a signal 408 to the training service 404 that in the present embodiment uses a real-time publish-subscribe service, a presence service more specifically, and an associated protocol as enabling technologies. Thus, message/signal 408a is published to training service 404 addressed to the mobile phone's 402a tuple 410a.

How the training service responds depends upon the initial associations configured in the training service 404a-g and the changes to the associations that have occurred as a result of operating the devices 402a-g. Each of devices 402a-g publishes its state or status including an action identifier for tracking device operation to its tuple 410a-g maintained by training service 404, thus, whenever a device performs an action that causes a state or status change, training service 404 receives a publish message/signal from the device.

Training service 404 is configured to maintain associations for functionally similar purposes of those previously described. An association maintained by training service 404, in an embodiment, includes a signal identifier, an action identifier, and a correlation as described in the system 200. Each association, in the embodiment of training service 404, also includes an identifier of a device capable of performing the identified action. Device capable of performing an action may be configured. They are also learned from the publish messages/signals that include an action identifier. Further, the action identifier, in the embodiment is in a format recognizable by the identified device as a command to perform the associated action.

Continuing with the example of mobile phone 402a sending a signal 408 in a publish message to mobile phone tuple 410a, training service 404 sends an action identifier from an association located in its correlation association database (not shown) in a notify message 412 to a DVR 402b causing the DVR 402b to load a stream for playback. The association, in addition to including the action identifier, includes an identifier of the signal 408, an identifier of the DVR 402, and a correlation, where the correlation met a threshold condition of a policy maintained by the training service 404.

In response to receiving the message 412 including the action identifier, DVR 402b performs the action and sends a signal 414 to its tuple 410b indicating its new state or status. Training service 404, using its associations and policies in the manner described, sends a notify message 416 to a TV/display 402c including an action identifier of an association including an identifier of the signal 414, the action identifier, an identifier of the TV/display 402c, and a correlation such that the correlation meets a policy. The action identifier received by the TV/display 402c causes TV/display 402c to enter a state where it is ready to receive a stream of video media from DVR 402b. In the same manner, training service 404 also sends a notify message/signal 418 to an audio receiver/amplifier 402d including an action identifiers that causes audio receiver/amplifier 402d to enter a state where it is ready to receive and audio stream from DVR 402b. The chain reaction of publish commands including signals and notify commands including action identifiers continues including a publish command including a signal 420 from audio receiver/amplifier 402d, resulting in a notification 422 including an action identifier sent to a speaker system 402f causing speaker system 402f to be put in a state enabled to receive audio from audio receiver/amplifier 402d. Thus, system 400 is in a ready state prepared to play a stream transmitted from DVR 402b as a result of a signal 408 from mobile phone 402a.

Which devices receive notifications including commands may be pre-specified using a friends list managed by a friends list manager 424. That is, a friends list may be used as an association database. In one embodiment, training service 404 may be installed with no pre-configured associations and all entities are watchers of each other entity. That is, everyone is everyone else's friend and all messages are broadcast. As a result of learning, actions are associated with signals and subscribers/friends are pruned when no association is detected between a signal and an action of a given device or when a correlation in an association is used to determine that the correlation meets a pruning policy indicating the association is to be deleted.

A signal may be broadcast, sent to a list of device services detected on the network or preset, or may be sent to a proxy, which determines routing or notification of the received signal.

Peer-to-peer and centralized architectures as described are two ends of a spectrum of alternate embodiments that use a mix of both. Thus, the subject matter described herein may be implemented using a peer-to-peer architecture, a centralized architecture using a training service, or a combination of the two architectures.

According to one enhancement of the subject matter described herein, a multi-signal association may be created including received signals, an action and a correlation. The correlation serves as a multi-signal correlation associating the signals and the action. For example, after the first signal is received in block 102 of FIG. 1, a second signal may be received. A multi-signal association may be created including the first and second signals. That is, context input to be associated with a first signal may include a second signal. An association record may be created in correlation association database 222 that includes the first signal, the second signal, an action, and a correlation. The action may be identified in the context input in addition to the second signal. This association is maintained just as single signal association except that both signals must occur. That is, the two signals may be treated as one. The two signals when received together, meaning, for example, in a particular order and/or within a given time period, may in effect be treated as a single signal or signal group. When the correlation becomes strong enough in an association including both signals such that it meets a threshold condition, an action in the association is performed. It may be the case that each signal is included in a separate single-signal association with the same action where neither of the separate single-signal associations alone is correlated strongly enough with the particular action to cause it to be performed. However, when the two signals occur together as described, the signals may be recognized as a received signal group due to the association including both signals. One can see that an association including more that two signals may be supported, that the order of the signals and the timing of the receiving of the signals may affect the correlation strength of the association depending on the embodiment. In addition to signal groups, correlation groups including combinations of signals, inputs, states of device, or sets of devices may be treated as a single signal in an association including a portion of the preceding information, an action, and a correlation. Analogously, a multi-action association may be supported including multiple actions so that a signal or signal group may be included in an association including multiple actions and a correlation for determining whether the multiple actions are to be performed when the signal or signal group is received. Thus, multi-signal, multi-action associations may be supported without departing from the scope of the subject matter described herein.

In another enhancement, if the signals that form a signal group are received a second time after a multi-signal association has been created, it may be determined whether the correlation indicates that an exception condition is met. Two types of exception conditions that may be used include predefined policies and learned exceptions. Predefined policies may indicate that the two signals should not occur together or never achieve correlations higher or lower than a specified threshold. Learned exceptions may include input from the user that teaches the device that a signal received in a certain context should generate an exception. Thus, an exception is simply a type of action that can be performed. If an exception condition is met, an exception message may be generated and sent to an exception handler for processing.

In one example application of the subject matter described herein, Schony, Inc., a diversified company in the media, computing, gaming, and home entertainment hardware business offers a complete line of home audio/video equipment including wide-screen displays, DVR devices, DVD devices, audio receivers, amplifiers, speakers, surround sound systems, remote controls, etc. Schony also supplies a training service device as a stand-alone device, integrated into a home media PC, and integrated into a HDTV wide-screen display. Schony preconfigures its training services offerings with subscriptions and associations of signals, actions, and correlations so that a Schony system is automated “out-of-the-box” but customizes its operation based on its usage in a given home.

The Hunt family, also a diversified group, has a Schony home audio/video system, but the family's DVR is provided by Tim Wiener Cable Co., which buys its DVRs from Scientific Alabama owned by Crisco Networks. The DVR is an ordinary DVR that takes command input, but is not enabled to learn the meaning of signals or even receive signals. It is enabled, however, to report its status including actions performed to a presence service, as Crisco Networks is a leader in presence technology.

Upon installation, the Schony home system responds automatically tailored to the varied uses of the Hunt family. The DVR initially has to be operated manually, but reports each operation to the presence service in the Schony training service. The training services makes associations among signals generated by other devices and the status updates of the DVR which include the command code or action identifier(s) associated with each status update. Thus, the associations each include a signal, an action identifier (i.e. a DVR command code), a device or service identifier, and a correlation. Manual inputs that get repeated in a given context become more and more correlated with the associated DVR actions IDs. When a correlation in an association meets a threshold condition of a policy used by the training service, the training service sends the DVR the associated action ID when a signal or signal group including in the association is received. The Hunt family members are relieved of manually operating their DVR in a fairly brief period of time. As their use of their system changes, the training systems adjusts correlations tuning the operation of the system to the evolving usage patterns of the growing and maturing Hunt family.

According to one aspect, the subject matter described herein includes a system for a self-automating set of services or devices. The system may include means for receiving a first signal. For example, I/O subsystem 208 of device 204 illustrating FIG. 2 may receive signal 202.

The system may further include means for determining a first action having the first correlation with the first signal. For example, policy manager 220 may locate an association in correlation association database 222 that includes the first signal, an action, and a correlation indicating the strength of the association with the first signal and the action.

The system may further include means for performing the first action if the correlation of the first action with the first signal meets a threshold condition. For example, policy manager 220 may determine whether the correlation in the located association record meets a threshold condition. If the threshold is met, the action included in the association with the first signal is performed.

The system may further include means for receiving input associated with the second action after performing the first action. For example, policy manager 220 may receive context input associated with the second action after the first action is performed.

The system may further include means for adjusting the correlation of the first action with the first signal based on the second action. For example, policy manager 220 may strengthen or weaken the correlation depending on whether the first and second actions are related.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for a self-automating set of services or devices, the method comprising:
while in a mode for providing a service and for device interoperability learning:
receiving a first signal;
determining a first action having a first correlation with the first signal;
performing the first action if the first correlation meets a threshold condition;
receiving input associated with a second action after performing the first action; and
adjusting the first correlation based on the second action.

2. The method of claim 1 wherein:
receiving a first signal includes receiving the first signal at a device;
determining a first action includes locating an association including the first signal, the first action, and the first correlation, wherein the first correlation is, a member of a set including at least three correlations; and
performing the first action includes performing the first action in response to the first action being indicated by a policy based on the first correlation.

3. The method of claim 1 wherein receiving a first signal includes receiving the first signal at a first device from a second device, wherein the first signal is not correlated to any actions the first and second devices can perform.

4. The method of claim 1 comprising determining that the first and second actions are equivalent and wherein adjusting the first correlation includes adjusting the first correlation as a result of the determination.

5. The method of claim 1 comprising determining that the first and second actions are not equivalent.

6. The method of claim 5 wherein adjusting the first correlation comprises weakening the first correlation in response to determining that the first and second actions are not equivalent.

7. The method of claim 5 wherein determining a first action includes locating a first association including the first action, the first signal, and the first correlation, and wherein the method further comprises, in response to determining that the first and second actions are not equivalent:
locating a second association including the first signal, the second action, and a second correlation; and
adjusting the second correlation after the second association is located.

8. The method of claim 5 wherein determining a first action includes locating a first association including the first action, the first signal, and the first correlation, and wherein the method further comprises, in response to determining that the first and second actions are not equivalent:
creating a second association including the first signal and the second action; and
including a second correlation in the second association, wherein the second correlation is selected from a plurality of correlations.

9. The method of claim 1 comprising determining a strongest correlation from a plurality of correlations associating the first signal with a corresponding plurality of actions and performing one of the plurality of actions having the strongest correlation with the first signal.

10. The method of claim 5 comprising, in response to determining that the first and second actions are not equivalent, performing the second action after performing the first action and adjusting a correlation of the second action with the first signal.

11. The method of claim 1 comprising:
receiving a second signal after receiving the first signal; and
creating a multi-signal correlation associating the first and second signals and the second action.

12. The method of claim 11 comprising:
after receiving the first and second signals a second time, determining if a policy using the multi-signal correlation indicates that an exception condition is met; and
in response to determining that the policy indicates that the exception condition is met, generating an exception message and performing at least one of presenting the exception message via a user interface and transmitting the exception message enabling an exception handler to process the exception message.

13. The method of claim 11 comprising:
after receiving the first and second signals a second time, determining if a policy using the multi-signal correlation indicates that the second action should be performed; and
in response to determining that the policy using the multi-signal correlation indicates that the second action should be performed, adjusting the multi-signal correlation associating the first and second signals and the second action to a stronger correlation value.

14. A method for self automating a set of devices and services, the method comprising:
receiving a signal at a device;
locating an association including the signal, an action, and a correlation between the signal and the action, wherein the correlation is a member of a set of correlations having at least three members; and
performing the action when indicated by a policy based on the correlation.

15. A system for a self-automating set of devices or services, the system comprising:
an input/output (I/O) subsystem for receiving a first signal and for receiving input after receiving the first signal;
a policy manager for, while in a mode for providing a service and for device interoperability learning:
receiving the first signal from the I/O subsystem; determining a first action having a first correlation with the first signal;
performing the first action if the first correlation meets a threshold condition;
receiving the input from the I/O subsystem, the input being associated with a second action; and
adjusting the first correlation based on the second action.

16. The system of claim 15 comprising a device, wherein the I/O subsystem and the policy manager are components of the device and wherein the policy manager is adapted to:
locate an association including the first signal, the first action, and the first correlation, wherein the first correlation is a member of a set including at least three correlations; and
perform the first action when indicated by a policy based on the first correlation.

17. The system of claim 15 comprising a first device, wherein the I/O subsystem and the policy manager are components of the first device, wherein receiving a first signal includes receiving the first signal at the first device from a second device, wherein the first signal is not correlated to any actions that the first and second devices can perform.

18. The system of claim 15 wherein the policy manager is adapted to determine that the first and second actions are equivalent and to adjust the first correlation as a result of the determination.

19. The system of claim 15 wherein the policy manager is adapted to determine that the first and second actions are not equivalent.

20. The system of claim 19 wherein the policy manager is adapted to weaken the first correlation in response to determining that the first and second actions are not equivalent.

21. The system of claim 19 wherein the policy manager is adapted to locate a first association including the first action, the first correlation, and the first signal, and, in response to determining that the first and second actions are not equivalent:
locate a second association including the first signal, the second action, and a second correlation; and
adjust the second correlation after the second association is located.

22. The system of claim 19 wherein the policy manager is adapted to locate a first association including the first action, the first correlation, and the first signal, and, in response to determining that the first and second actions are not equivalent:
create a second association including the first signal and the second action; and
include a second correlation in the second association, wherein the second correlation is selected from a plurality of correlations.

23. The system of claim 15 wherein the policy manager is adapted to determine a strongest correlation from a plurality of correlations that associate the first signal with a corresponding plurality of actions and to initiate performance of an action associated with the strongest correlation.

24. The system of claim 19 wherein the policy manager is adapted to, in response to determining that the first and second actions are not equivalent, initiate performance of the second action after the first action and adjust a correlation of the second action with the first signal.

25. The system of claim 15 wherein the policy manager is adapted to:
receive a second signal after receiving the first signal; and
create a multi-signal correlation associating the first and second signals and the second action.

26. The system of claim 25 wherein the policy manager is adapted to:
after receiving the first and second signals a second time, determine if a policy based on the multi-signal correlation indicates that an exception condition is met; and
in response to determining that the policy indicates that the exception condition is met generate an exception message, perform at least one of presenting the exception message via a user interface and transmitting the exception message enabling an exception handler to process the exception message.

27. The system of claim 25 wherein the policy manager is adapted to:
after receiving the first and second signals a second time, determine if a policy based on the multi-signal correlation indicates that the second action should be performed; and
in response to determining that the policy based on the multi-signal correlation indicates that the second action should be performed, adjust the multi-signal correlation associating the first and second signals and the second action to a stronger correlation value.

28. A system for self automating a set of services and devices, the system comprising:
while in a mode for providing a service and for device interoperability learning:
means for receiving a first signal;
means for determining a first action having a first correlation with the first signal;
means for performing the first action if the first correlation meets a threshold condition;
means for receiving input associated with a second action after performing the first action; and
means for adjusting the first correlation based on the second action.

29. A computer readable medium containing a computer program, executable by a machine for a self-automating set of devices or services, the computer program comprising executable instructions for:
while in a mode for providing a service and for device interoperability learning:
receiving a first signal;
determining a first action having a first correlation with the first signal;
performing the first action if the first correlation meets a threshold condition;
receiving input associated with a second action after performing the first action; and
adjusting the first correlation based on the second action.
